(19) United States
(12) Patent Application Publication
(10) Pub. No.: US 2026/0042691 A1
(43) Pub. Date: Feb. 12, 2026

(54) SEAWATER DESALINATION METHOD AND SEAWATER DESALINATION SYSTEM PERFORMING THE SAME

(71) Applicant: Korea Advanced Institute of Science and Technology, Daejeon (KR)

(72) Inventors: Tae-Hyun Bae, Daejeon (KR); Chihyuk Ahn, Daejeon (KR); Jihun Mun, Daejeon (KR)

(73) Assignee: Korea Advanced Institute of Science and Technology, Daejeon (KR)

(21) Appl. No.: 19/205,151

(22) Filed: May 12, 2025

(30) Foreign Application Priority Data
Aug. 6, 2024 (KR) 10-2024-0104639

(51) Int. Cl. C02F 9/00; B01D 61/02; B01D 69/02; C01F 5/24; C01F 11/18; C02F 1/24; C02F 1/44; C02F 1/66; C02F 101/10; C02F 103/08

(52) U.S. Cl. CPC C02F 9/00; B01D 61/025; B01D 61/027; B01D 61/029; B01D 69/02; C01F 5/24; C01F 11/18; B01D 2311/06; B01D 2317/025; B01D 2325/02831; B01D 2325/02832; C02F 1/24; C02F 1/441; C02F 1/442; C02F 1/66; C02F 2101/101; C02F 2103/08

(57) ABSTRACT

A seawater desalination method according to the present disclosure comprises separating a seawater into a filtrate water and a concentrated water using a nano filter membrane, processing the filtrate water through a desalination and generating a carbonate by reacting the concentrated water and a flue gas.

### CROSS-REFERENCE TO RELATED APPLICATION(S)

This application claims priority under 35 U.S.C. §119 to Korean Patent Application No. 10-2024-0104639, filed on Aug. 6, 2024, which is hereby incorporated by reference for all purposes as if fully set forth herein.

### BACKGROUND

### 1. Field

Embodiments relate to a seawater desalination method and a seawater desalination system performing the same. More particularly, embodiments relate to the seawater desalination method based on reverse osmosis and the seawater desalination system performing the same.

### 2. Description of the Related Art

In order to secure sustainable water resources, importance of seawater desalination processes is increasing. The desalination process may include heat-based desalination processes and membrane-based desalination process. The heat-based desalination process involve a process of changing water into steam so that a lot of energy may be required to perform the heat-based desalination process. The membrane-based desalination process utilize membrane-based reverse osmosis phenomena so that energy efficient in the membrane-based desalination process can be larger than in the heat-based desalination process.

Reverse osmosis-based desalination processes may include a preprocess such as dissolved air flotation and ultrafiltration to remove suspended particles and particulate matter from seawater to minimize membrane fouling. The membrane used in the preprocess is a reverse osmosis membrane that allows water to pass through but hardly allows ionic materials to pass through, so when seawater is pressurized, only fresh water can pass through the reverse osmosis membrane.

### SUMMARY

Embodiments provide an environmentally and economically sustainable seawater desalination method.

Embodiments provide a seawater desalination system performing the seawater desalination method.

A seawater desalination method according to an embodiment includes separating a seawater into a filtrate water and a concentrated water using a nano filter membrane, processing the filtrate water through a desalination, and generating a carbonate by reacting the concentrated water and a flue gas.

In an embodiment, the separating of a seawater into a filtrate water and a concentrated water may include processing the seawater through a dissolved air flotation and filtering using a nano filter membrane.

In an embodiment, the nano filter membrane may be configured to permit a monovalent ion included in the seawater, and the monovalent ion may include at least one selected from a group consisted of sodium ion(Na⁺), potassium ion(K⁺), lithium ion(Li⁺) and chlorine ion(Cl⁻).

In an embodiment, the nano filter membrane may separate the seawater into the concentration water by filtering a divalent ion included in the concentrated water, and the divalent ion may include at least one selected from a group consisted of magnesium ion(Mg²⁺), calcium ion(Ca²⁺), sulfate ion(SO₄²⁻).

In an embodiment, a size of a pore of the nano filter membrane may be about 0.5 nm or more and about 2.0 nm or less.

In an embodiment, the generating of the carbonate may include increasing a pH by providing an alkaline material to the concentrated water providing the concentrated water to a shell side of a hollow fiber membrane module, and providing a flue gas to a lumen side of the hollow fiber membrane module.

In an embodiment, the hollow fiber membrane module may include a first hollow fiber membrane module and a second hollow fiber membrane module. And in the generating of the carbonate may include providing the concentrated water, the alkaline material, and the flue gas to the first hollow fiber membrane module, generating a first carbonate in the first hollow fiber membrane module by reacting the flue gas and calcium ion included in the concentrated water, providing the concentrated water, the alkaline material, and the flue gas to the second hollow fiber membrane module, and generating a second carbonate different from the first carbonate in the second hollow fiber membrane module by reacting the flue gas and magnesium included in the concentrated water.

In an embodiment, in the providing of the concentrated water, the alkaline material, and the flue gas to the first hollow fiber membrane module and in the generating of the first carbonate, a pH of a fluid flowing on a shell side of the first hollow fiber membrane module may be about 8 or more and about 10 or less. And in the providing of the concentrated water, the alkaline material, and the flue gas to the second hollow fiber membrane module and in the generating of the second carbonate, a pH of a fluid flowing on a shell side of the second hollow fiber membrane module may be about 10 or more and about 14 or less. And the first carbonate may be calcium carbonate (CaCO₃), and the second carbonate may be magnesium carbonate (MgCO₃).

A seawater desalination system according to an embodiment includes a preprocessor configured to separate a seawater into a filtrate water and a concentrated water by preprocessing the seawater, a fresh water generator configured to generate a fresh water from the filtrate water from the preprocessor, and a membrane contactor in which each of a flue gas and an alkaline material inflow and configured to capture a carbon dioxide by reacting a concentrated water received from the preprocessor and the flue gas.

In an embodiment, the preprocessor may include a pressurized flotation module configured to remove a foreign material from the seawater and a nano filter module configured to separate the seawater received from the pressurized flotation module into the filtrate water and the concentrated water. And the membrane contactor may include a first hollow fiber membrane module configured to exhaust a first carbonate generated by reacting a calcium ion included in the concentrated water and the flue gas and a second hollow fiber membrane module configured to exhaust a second carbonate generated by reacting a magnesium ion included in the concentrated water and the flue gas.

In a seawater desalination method according to embodiments of the present disclosure, by decreasing a salt concentration of a filtrate water flowing into a freshwater generator through a preprocessing of the seawater, energy and cost required for operating the freshwater generator may be reduced.

In addition, the seawater desalination method may increase a capacity of carbon dioxide captured at a membrane contactor through a separating of the seawater into a concentrated water including a divalent ion, and may ultimately reduce ion concentration of the concentrated water discharged from the membrane contactor. Accordingly, emission of greenhouse gases may be reduced, and a carbon tax may be reduced, thereby further reducing cost of the process using the seawater desalination method.

In addition, in a seawater desalination method, since carbonate containing calcium carbonate and magnesium carbonate is produced, the cost of the process using the seawater desalination method may be further reduced by selling the produced carbonate.

In a seawater desalination system according to embodiments of the present disclosure, since the seawater desalination system includes a first hollow fiber membrane module and a second hollow fiber membrane module including a hollow fiber membrane contactor are included, rejection and capture efficiency of the carbon dioxide included in a flue gas may be improved. In addition, by controlling a pH of a shell side of each of the first hollow fiber membrane module and the second hollow fiber membrane module, a calcium ion and a magnesium ion included in the concentrated water may be automatically separated, thereby further reducing the process cost and time using the seawater desalination system.

### BRIEF DESCRIPTION OF THE DRAWINGS

Illustrative, non-limiting embodiments will be more clearly understood from the following detailed description in conjunction with the accompanying drawings.

FIG. 1 is a flow chart illustrating a seawater desalination method according to an embodiment of the present disclosure.

FIG. 2 is a block diagram illustrating a seawater desalination system performing the seawater desalination method of FIG. 1.

FIGS. 3 and 4 are drawings explaining for effects of the seawater desalination method of FIG. 1 and the seawater desalination system of FIG. 2

### DETAILED DESCRIPTION OF THE EMBODIMENTS

Hereinafter, a seawater desalination method and a seawater desalination system performing the same in accordance with embodiments will be described in more detail with reference to the accompanying drawings. The present disclosure can be modified in various ways and can take various forms, and specific embodiments will be illustrated and described in detail in the text. However, this is not intended to limit the present disclosure to a specific disclosed form, and it should be understood that it includes all modifications, equivalents, or substitutes included in the spirit and technical scope of the present disclosure. In the attached drawings, the dimensions of structures may be illustrated to be larger than actual dimensions for the clarity of the present disclosure.

The terms used in this application are only used to describe specific embodiments and are not intended to limit the present disclosure. A singular expression includes the plural expression unless the context clearly indicates otherwise. In this application, terms “include” or “have” are intended to indicate the presence of a feature, number, step, operation, component, or combination thereof described in the specification, but should be understood as not excluding in advance the possibility of the presence or addition of one or more other features, numbers, steps, operations, components, or combinations thereof.

Unless otherwise defined, all terms used herein, including technical or scientific terms, have the same meaning as generally understood by a person of ordinary skill in the art to which the present disclosure pertains. Terms defined in commonly used dictionaries should be interpreted as having a meaning consistent with the meaning they have in the context of the relevant technology, and shall not be interpreted in an ideal or excessively formal sense unless explicitly defined in this application.

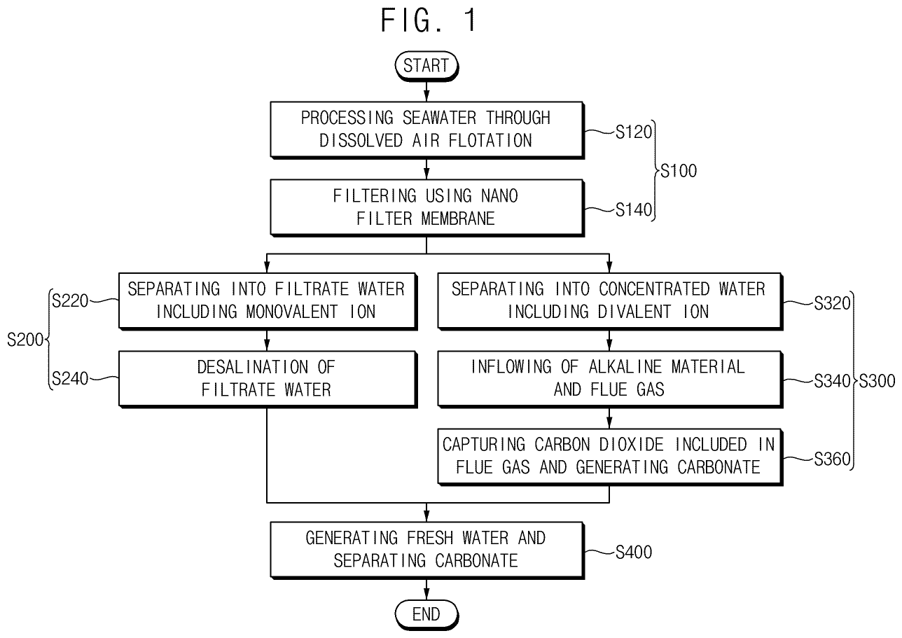

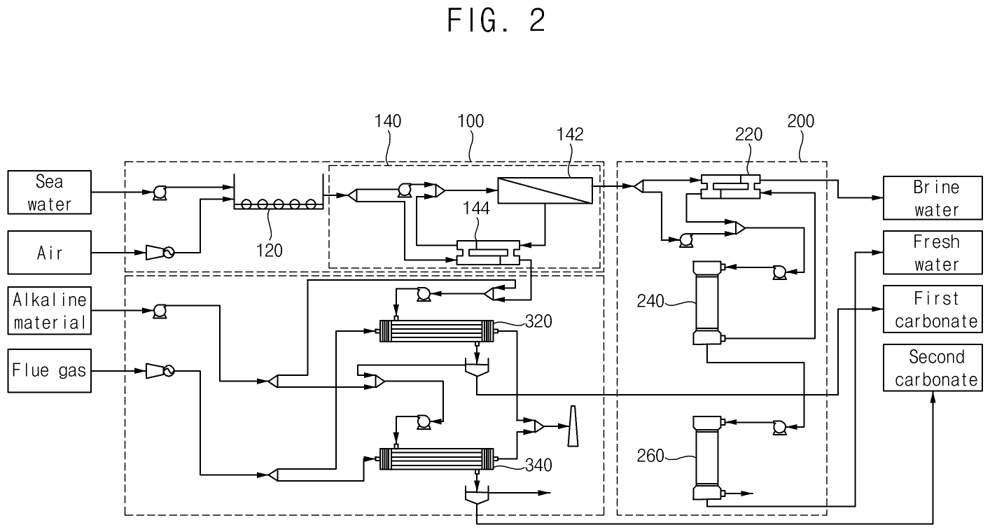

FIG. 1 is a flow chart illustrating a seawater desalination method according to an embodiment of the present disclosure. FIG. 2 is a block diagram illustrating a seawater desalination system performing the seawater desalination method of FIG. 1.

Referring to FIGS. 1 and 2, the seawater desalination method according to an embodiment of the present disclosure may include preprocessing the seawater S100, processing a filtrate water separated from the seawater through a desalination S200, capturing a carbon dioxide using a concentrated water separated from the seawater S300, and generating a fresh water and separating a carbonate S400. The preprocessing of the seawater S100 may include processing the seawater through a dissolved air flotation S120 and filtering using a nano filter membrane 142 S140. The processing of the filtrate water separated from the seawater through the desalination S200 may include separating into the filtrate water including a monovalent ion S220 and processing the filtrate water through the desalination S240. The capturing of the carbon dioxide using the concentrated water separated from the seawater S300 may include separating into the concentrated water including a divalent ion S320, inflowing of an alkaline material and a flue gas S340, and capturing the carbon dioxide included in the flue gas and generating the carbonate S360.

In the disclosure, the filtering using the nano filter membrane 142 S140, the separating into the filtrate water including the monovalent ion S220, and the separating into the concentrated water including the divalent ion S320 may be referred to as separating the seawater into the filtrate water and the concentrated water using the nano filter membrane 142 together. In addition, the inflowing of the alkaline material and a flue gas S340, the capturing of the carbon dioxide included in the flue gas and generating the carbonate S360, and the generating of the fresh water, and the separating of the carbonate S400 may be referred to as the generating of the carbonate reacting the concentrated water and the flue gas.

The seawater desalination system performing the seawater desalination method may include a preprocessor 100, a fresh water generator 200, and a membrane contactor 300. The preprocessor 100 may include a pressurized flotation module 120 and a nano filter module 140. The nano filter module 140 may include the nano filter membrane 142 and a first pressure converter 144. The fresh water generator 200 may include a second pressure converter 220, a first reverse osmosis part 240, and a second reverse osmosis part 260. The membrane contactor 300 may include a first hollow fiber membrane module 320 and a second hollow fiber membrane module 340.

The seawater may refer to sea or ocean water including various types of ionic materials. The seawater may need to be extracted as cleanly as possible in order to minimize a load generated in the preprocessing of the seawater S100, and the seawater may be extracted through a process for obtaining high-quality raw water. For example, the process for obtaining the high-quality raw water may include extracting deep seawater at a depth of 60 m or more, installing a well in an underground aquifer, an infiltration gallery, and/or the like.

The seawater may be introduced into the preprocessor 100 and preprocessed. In an embodiment, the pressurized flotation module 120 may perform the processing of the seawater through the dissolved air flotation S120, thereby removing foreign materials included in the seawater. For example, the foreign materials may include suspended solids, inorganic compounds, organic pollutants, and/or the like. that may cause contamination or damage to the reverse osmosis part (e.g., the first reverse osmosis part 240 and the second reverse osmosis par 260). Specifically, the suspended solids include colloids and particulate matter, the inorganic compounds include manganese (Mn), calcium carbonate (CaCO₃), calcium sulfate (CaSO₄), silicon dioxide (SiO₂), and/or the like., and the organic pollutants may include organic materials and microorganisms in the seawater.

The pressurized flotation module 120 may include a pressure pump, a saturator, and a flotation chamber. When the seawater and air are flowing into the pressurized flotation module 120, a pressure having a relatively larger intensity than the flotation chamber may be applied to the saturator using the pressure pump to increase a solubility of the seawater. Thereafter, bubbles generated by the pressure difference between the saturator and the flotation chamber combine with the foreign materials included in the seawater, so that the pressurized flotation module 120 may remove the foreign materials from the seawater.

The seawater processed through the dissolved air flotation may inflow into the nano filter module 140. In an embodiment, the nano filter module 140 may perform the filtering using the nano filter membrane 142, thereby the performing of separating the seawater into the filtrated water including the monovalent ion S220 and the separating of the concentrated water including the divalent ion S320 may be performed.

The nano filter membrane 142 may permit the monovalent ion included in the seawater to pass through. In addition, the nano filter membrane 142 may not permit the divalent ion included in the seawater to pass through. Accordingly, the nano filter membrane 142 may separate the monovalent ion and the divalent ion included in the seawater. In an embodiment, in the filtering using the nano filter membrane 142 S140, a pressure applied to the nano filter module 140 may have a strength of about 15 bar or less.

In an embodiment, the monovalent ion may include sodium ion (Na+), potassium ion (K+), lithium ion (Li+), chlorine ion (Cl−), and the like. These may be used alone or in combination with each other. In an embodiment, the divalent ion may include magnesium ion (Mg2+), calcium ion (Ca2+), sulfate ion (SO42−), and the like. These may be used alone or in combination with each other.

In an embodiment, a size of a pore of the nano filter membrane 142 may be larger than a size of a pore of the reverse osmosis membrane included in each of the first reverse osmosis part 240 and the second reverse osmosis part 260. In addition, the pore size of the nano filter membrane 142 may be smaller than the pore size of an ultrafiltration membrane used in an ultrafiltration process. Accordingly, the nano filter membrane 142 may separate the monovalent ion and the divalent ion from the seawater.

In an embodiment, a size of a pore of the nano filter membrane 142 may be about 0.3 nm or more and about 5 nm or less. Preferably, a size of a pore of the nano filter membrane 142 may be about 0.5 nm or more and about 2 nm or less.

The nano filter module 140 may transfer the filtrated water separated by the nano filter membrane 142 to the freshwater generator 200. The nano filter module 140 may transfer the concentrated water separated by the nano filter membrane 142 to the membrane contactor 300. In addition, the first pressure converter 144 may pressurize the seawater by utilizing a pressure difference between the concentrated water and the seawater. Accordingly, cost of pressurizing the seawater to the pressure of the nano filter module 140 may be reduced, and the concentrated water separated by the nano filter membrane 142 may be transferred to the membrane contactor 300 in a state of atmospheric pressure.

The freshwater generator 200 may perform the desalinating the filtrated water S240. In addition, the freshwater generator 200 may perform the generating of the freshwater among the generating of the freshwater and separating of the carbonate S400.

The freshwater generator 200 may generate the freshwater from the seawater preprocessed in the preprocessor 100. The second pressure converter 220 may decrease an intensity of the pressure applied to the filtrated water. Specifically, the second pressure converter 220 may pressurize the filtrated water by utilizing the pressure difference between a brackish water desalinated by the first reverse osmosis part 240 and the filtrated water. The filtrated water, an intensity of which is decreased by the second pressure converter 220, may be transferred to the first reverse osmosis part 240. In addition, the second pressure converter 220 may discharge a brine water by passing the filtrated water that is not transferred to the first reverse osmosis part 240.

The first reverse osmosis part 240 may include a reverse osmosis membrane that performs desalination treatment using reverse osmosis. In an embodiment, the first reverse osmosis part 240 may be a reverse osmosis plant using a sea water reverse osmosis (SWRO). The first reverse osmosis part 240 may perform a primary desalination process on the filtrated water to generate the brackish water. The brackish water delivered from the first reverse osmosis part 240 may be introduced into the second reverse osmosis part 260. In an embodiment, the second reverse osmosis part 260 may be a reverse osmosis plant using a brackish water reverse osmosis (BWRO). The second reverse osmosis part 260 may perform a secondary desalination process on the brackish water to produce the fresh water. However, a number of reverse osmosis parts included in the fresh water generator 200 according to the embodiments of the present disclosure is illustrated as two, but may not be limited thereto, and a number of reverse osmosis parts included in the fresh water generator 200 may be one or three or more.

The membrane contactor 300 may perform the inflowing of the alkaline material and the flue gas S340 and capturing of the carbon dioxide included in the flue gas and generating the carbonate S360. The membrane contactor 300 may capture the carbon dioxide by reacting the flue gas and the foreign material.

In an embodiment, each of the first hollow fiber membrane module 320 and the second hollow fiber membrane module 340 may include a hollow fiber membrane contactor (HFMC) including a hollow fiber membrane. Although the membrane contactor 300 according to the embodiment of the present disclosure is illustrated as including two hollow fiber membrane modules, the present disclosure may not be limited thereto, and the membrane contactor 300 according to the embodiment of the present disclosure may include one or three or more hollow fiber membrane modules.

The membrane contactor 300 may be provided with the flue gas. For example, the flue gas may flow into a lumen side of the first hollow fiber membrane module 320. In addition, the flue gas may flow into a lumen side of the second hollow fiber membrane module 340. The flue gas may include nitrogen and the carbon dioxide. For example, a volume ratio of the nitrogen included in the flue gas may be about 70% or more and about 85% or less, and a volume ratio of the carbon dioxide included in the flue gas may be about 10% or more and about 25% or less. However, volume ratios of the nitrogen and the carbon dioxide included in the flue gas included in the present disclosure may not be limited thereto, and the volume ratios of the nitrogen and the carbon dioxide included in the flue gas may have various values.

The membrane contactor 300 may be provided with the concentrated water and the basic material. For example, the concentrated water and the alkaline material may flow into the shell side of the first hollow fiber membrane module 320. In addition, the concentrated water and the alkaline material may be introduced into the shell side of the second hollow fiber membrane module 340. In an embodiment, the alkaline material may include sodium hydroxide (NaOH), potassium hydroxide (KOH), calcium hydroxide (Ca(OH)₂), and the like. These may be used alone or in combination with each other.

However, a type of fluid flowing into each of the shell side and the lumen side of the first hollow fiber membrane module 320 according to the embodiments of the present disclosure may not be limited thereto. In addition, a type of fluid flowing into each of the shell side and the lumen side of the second hollow fiber membrane module 340 according to the embodiments of the present disclosure may not be limited thereto. For example, gas (e.g., the flue gas) may flow into each of the shell sides of the first hollow fiber membrane module 320 and the second hollow fiber membrane module 340, and liquid (e.g., the concentrated water) may flow into each of the lumen side of the first hollow fiber membrane module 320 and the second hollow fiber membrane module 340.

The alkaline material may be provided to the concentrated water so that increase a pH of the concentrated water. For example, the alkaline material may flow into the shell side of the first hollow fiber membrane module 320 together with the concentrated water received from the nano filter module 140. Accordingly, the concentrated water flowing into the first hollow fiber membrane module 320 may have alkalinity. In addition, the concentrated water with increased pH and the flue gas flowing into the lumen side of the first hollow fiber membrane module 320 may react. Specifically, the calcium ion included in the concentrated water and the carbon dioxide included in the flue gas may react to generate the first carbonate.

In an embodiment, the first carbonate may be calcium carbonate (CaCO₃). In an embodiment, the pH of the fluid (e.g., the concentrated water) flowing within the shell side of the first hollow fiber membrane module 320 may be about 8 or more and about 10 or less. Preferably, the pH of the fluid flowing within the shell side of the first hollow fiber membrane module 320 may be about 8 or more and about 9 or less. Accordingly, since the pH of the fluid flowing within the shell side of the first hollow fiber membrane module 320 is about 10 or less, the calcium ion may be easily separated from the concentrated water.

The alkaline material may inflow into the shell side of the second hollow fiber membrane module 340 together with the concentrated water received from the first hollow fiber membrane module 320. Accordingly, the concentrated water flowing into the second hollow fiber membrane module 340 and the flue gas flowing into the lumen side of the second hollow fiber membrane module 340 may react. Specifically, the magnesium ion included in the concentrated water and the carbon dioxide included in the flue gas may react to generate the second carbonate. In an embodiment, the second carbonate may be magnesium carbonate (MgCO₃).

In an embodiment, the pH of the fluid (e.g., the concentrated water) flowing within the shell side of the second hollow fiber membrane module 340 may be about 10 or more and about 14 or less. Preferably, the pH of the fluid flowing within the shell side of the second hollow fiber membrane module 340 may be about 10 or more to about 12 or less. Accordingly, since the pH of the fluid flowing within the shell side of the second hollow fiber membrane module 340 is about 10 or larger, the magnesium ions may be easily separated from the concentrated water.

As described above, the seawater desalination method may reduce the energy and cost required for operating the freshwater generation part 200 by decreasing a salt concentration of the filtrated water flowing into the freshwater generator 200 through the preprocessing of the seawater S100.

In addition, the seawater desalination method may increase a capacity of the carbon dioxide captured in the membrane contactor 300 through the separating the seawater into the concentrated water including the divalent ion S200, and may ultimately reduce ion concentration of the concentrated water discharged from the membrane contactor 300. Accordingly, emission of greenhouse gases may be reduced and the carbon tax may be reduced, thereby further reducing the cost of the process using the seawater desalination method.

In addition, since the seawater desalination method generates a carbonate including the calcium carbonate and the magnesium carbonate, the cost of the process using the seawater desalination method may be further reduced by selling the generated carbonate.

In addition, since the seawater desalination system for performing the seawater desalination method includes the first hollow fiber membrane module 320 and the second hollow fiber membrane module 340 including the hollow fiber membrane contactor, rejection and capture efficiency of the carbon dioxide included in the flue gas may be improved. In addition, by controlling the pH of the shell side of each of the first hollow fiber membrane module 320 and the second hollow fiber membrane module 340, the calcium ion and the magnesium ion included in the concentrated water may be automatically separated, thereby further reducing the process cost and time using the seawater desalination system.

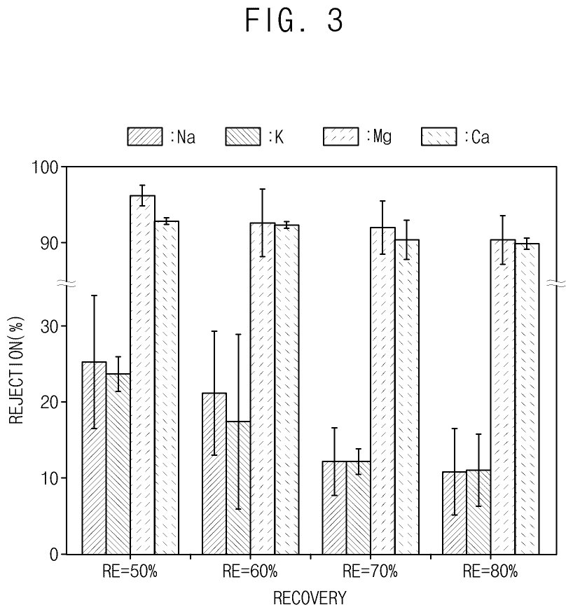

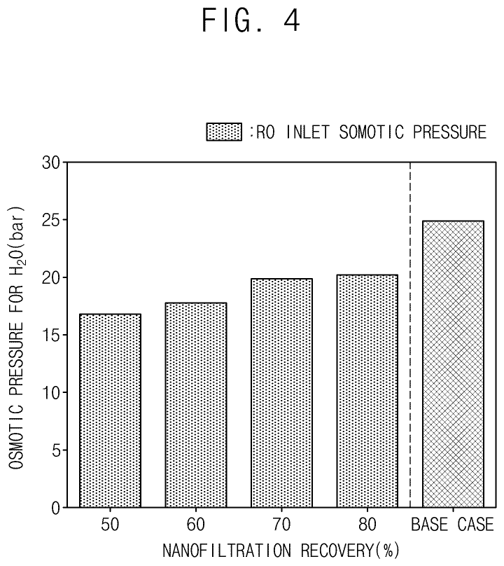

FIGS. 3 and 4 are drawings explaining for effects of the seawater desalination method of FIG. 1 and the seawater desalination system of FIG. 2

FIG. 3 is a graph measuring a rejection of monovalent and divalent ions included in seawater according to a recovery.

Referring to FIGS. 1, 2, and 3, an experiment was conducted in which artificial seawater containing sodium chloride (NaCl), potassium chloride (KCl), magnesium chloride (MgCl2), and calcium chloride (CaCl2) was introduced into a seawater desalination system according to experimental examples of the present disclosure. In the experiment, the nanofiltration recovery is defined as a ratio of the volume of filtrate passing through the nano filter membrane to a volume of feed entering the nano plant. The volume of the feed used in the experiment is 100 ml. The seawater desalination system according to Experimental Example 1 generated 50 ml of filtrated water from the feed having a volume of 100 ml, and had a nanofiltration recovery of 50%, the seawater desalination system according to Experimental Example 2 generated 60 ml of filtrated water from the feed having a volume of 100 ml, and had a nanofiltration recovery of 60%, the seawater desalination system according to Experimental Example 3 generated 70 ml of filtrated water from the feed having a volume of 100 ml, and had a nanofiltration recovery of 70%, and the seawater desalination system according to Experimental Example 4 generated 80 ml of filtrated water from the feed having a volume of 100 ml, and had a nanofiltration recovery of 80%. As the time for performing the experiment increases, the volume of the filtrated water passing through the nano plant increases, and therefore, the experimental example having a high nanofiltration recovery was an experimental example in which the concentration process through the nano filter membrane is performed for a relatively longer time than the experimental example having a low nanofiltration recovery. In addition, in each of Experimental Examples 1, 2, 3, and 4, pressure applied to the feed while passing the filtrated water through the nano filter membrane is 15 bar. In addition, the nano filter membrane included in each of Experimental Examples 1, 2, 3, and 4 is NF90. The pore size of the NF90 is 0.3 nm or more and 0.8 nm or less.

In Experimental Examples 1, 2, 3, and 4, a rejection of the magnesium ion and the calcium ion which are divalent ions, was measured to be higher than the rejection of the sodium ion and the potassium ion which are monovalent ion. Specifically, in Experimental Examples 1, 2, 3, and 4, the rejection of the monovalent ions was measured to be 10% to 25%, while the rejection of the divalent ions was measured to be 90% or more. In addition, a fact that the nano filter membrane according to the Experimental Examples had a higher rejection rate of the divalent ions included in the artificial seawater as the nanofiltration recovery was higher was confirmed. Specifically, the rejection of the monovalent ion was measured to be the lowest in Experimental Examples 3 and 4, where the nanofiltration recoverys were 70% and 80%, respectively. Accordingly, as the nanofiltration recovery increases and the volume of the filtrated water increases, the nano filter membrane more easily separates the monovalent ion and the divalent ion. Accordingly, the seawater desalination method and the seawater desalination system according to the embodiments of the present disclosure more easily capture carbon dioxide through the separated divalent ion.

FIG. 4 is a graph measuring an osmotic pressure of a reverse osmosis plant according to a recovery.

Referring to FIGS. 1, 2, 3, and 4, the artificial seawater was preprocessed, ion concentration of the filtrated water separated from the artificial seawater through the nano filter membrane was measured, and the osmotic pressure in the reverse osmosis plant included in each of Examples 1, 2, 3, and 4 was calculated based on the measured ion concentration. In addition, the osmotic pressure of the seawater desalination system not including the nano filter membrane and the membrane contactor was compared with that of Examples 1, 2, 3, and 4 as a comparative example. In the seawater desalination system, the reverse osmosis plant is a configuration corresponding to the freshwater generator 200, and the membrane contactor is a configuration corresponding to the membrane contactor 300.

Osmotic pressure intensity of the reverse osmosis plant measured in the comparative example was measured to be greater than the osmotic pressure intensity of the reverse osmosis plant measured in Experimental Examples 1, 2, 3, and 4. Specifically, the osmotic pressure of the reverse osmosis plants included in each of Experimental Examples 1, 2, 3, and 4 was measured to be 20 bar or less, but since the comparative example did not undergo a preprocess via the nano filter membrane, the osmotic pressure in the reverse osmosis plant in the comparative example was measured to be 25 bar. Accordingly, the seawater desalination method and the seawater desalination system according to the embodiments of the present disclosure including the process of preprocessing the seawater via the nano filter membrane may apply an osmotic pressure having a relatively lower intensity during the desalination process than the seawater desalination system and the seawater desalination method that do not use or include a nano filter membrane. Therefore, the seawater desalination method and the seawater desalination system according to the embodiments of the present disclosure may improve energy efficiency in the desalination process using the reverse osmosis membrane.

Although the methods and the systems according to the embodiments have been described with reference to the drawings, the illustrated embodiments are examples, and may be modified and changed by a person having ordinary knowledge in the relevant technical field without departing from the technical spirit described in the following claims.

What is claimed is:

1. A seawater desalination method comprising:
separating a seawater into a filtrate water and a concentrated water using a nano filter membrane;
processing the filtrate water through a desalination; and
generating a carbonate by reacting the concentrated water and a flue gas.

2. The seawater desalination method of claim 1, wherein the separating of a seawater into a filtrate water and a concentrated water includes:
processing the seawater through a dissolved air flotation; and
filtering using a nano filter membrane.

3. The seawater desalination method of claim 2, wherein the nano filter membrane is configured to permit a monovalent ion included in the seawater, and
the monovalent ion includes at least one selected from a group consisted of sodium ion(Na⁺), potassium ion(K⁺), lithium ion(Li⁺) and chlorine ion(Cl⁻).

4. The seawater desalination method of claim 2, wherein the nano filter membrane separates the seawater into the concentration water by filtering a divalent ion included in the concentrated water, and
the divalent ion includes at least one selected from a group consisted of magnesium ion(Mg²⁺), calcium ion(Ca²⁺), sulfate ion(SO₄²⁻).

5. The seawater desalination method of claim 2, wherein a size of a pore of the nano filter membrane is about 0.5 nm or more and about 2.0 nm or less.

6. The seawater desalination method of claim 1, wherein the generating of the carbonate includes:
increasing a pH by providing an alkaline material to the concentrated water;
providing the concentrated water to a shell side of a hollow fiber membrane module; and
providing a flue gas to a lumen side of the hollow fiber membrane module.

7. The seawater desalination method of claim 6, wherein the hollow fiber membrane module includes a first hollow fiber membrane module and a second hollow fiber membrane module, and
in the generating of the carbonate includes:
providing the concentrated water, the alkaline material, and the flue gas to the first hollow fiber membrane module;
generating a first carbonate in the first hollow fiber membrane module by reacting the flue gas and calcium ion included in the concentrated water;
providing the concentrated water, the alkaline material, and the flue gas to the second hollow fiber membrane module; and
generating a second carbonate different from the first carbonate in the second hollow fiber membrane module by reacting the flue gas and magnesium included in the concentrated water.

8. The seawater desalination method of claim 7, wherein in the providing of the concentrated water, the alkaline material, and the flue gas to the first hollow fiber membrane module and in the generating of the first carbonate, a pH of a fluid flowing on a shell side of the first hollow fiber membrane module is about 8 or more and about 10 or less,
in the providing of the concentrated water, the alkaline material, and the flue gas to the second hollow fiber membrane module and in the generating of the second carbonate, a pH of a fluid flowing on a shell side of the second hollow fiber membrane module is about 10 or more and about 14 or less,
the first carbonate is calcium carbonate (CaCO₃), and
the second carbonate is magnesium carbonate (MgCO₃).

9. A seawater desalination system comprising:
a preprocessor configured to separate a seawater into a filtrate water and a concentrated water by preprocessing the seawater;
a fresh water generator configured to generate a fresh water from the filtrate water from the preprocessor; and
a membrane contactor in which each of a flue gas and an alkaline material inflow and configured to capture a carbon dioxide by reacting a concentrated water received from the preprocessor and the flue gas.

10. The seawater desalination system of claim 9, wherein the preprocessor includes:
a pressurized flotation module configured to remove a foreign material from the seawater; and
a nano filter module configured to separate the seawater received from the pressurized flotation module into the filtrate water and the concentrated water,
wherein the membrane contactor includes:
a first hollow fiber membrane module configured to exhaust a first carbonate generated by reacting a calcium ion included in the concentrated water and the flue gas; and
a second hollow fiber membrane module configured to exhaust a second carbonate generated by reacting a magnesium ion included in the concentrated water and the flue gas.
